(19) United States
(12) Patent Application Publication
(10) Pub. No.: US 2025/0050949 A1
(43) Pub. Date: Feb. 13, 2025

(54) CRUSHABLE CRASH CUSHION TRANSITION

(71) Applicant: Lindsay Transportation Solutions, LLC, Omaha, NE (US)

(72) Inventors: Nathan Daniel Poppe, Omaha, NE (US); Robert Fulton Hendricks, Omaha, NE (US); Gerrit Andrew Dyke, Rio Vista, CA (US)

(21) Appl. No.: 18/797,833

(22) Filed: Aug. 8, 2024

Related U.S. Application Data
(60) Provisional application No. 63/518,139, filed on Aug. 8, 2023.

(51) Int. Cl. B62D 21/15

(52) U.S. Cl. CPC B62D 21/152

(57) ABSTRACT

An intermediate transition for connecting a crash cushion to a rigid structure includes a housing and an energy absorbing module. The housing defines an inner space and includes a top wall, a front wall, a rear wall, and a side wall. The front wall is operatively associated with the top wall and is operable to connect to the crash cushion. The rear wall is operatively associated with the top wall and is operable to connect to the rigid structure. The side wall is operatively associated with the top wall and includes a weakened portion. The energy absorbing module is located in the inner space of the housing.

### RELATED APPLICATION

The present application is a non-provisional application and claims priority benefit, with regard to all common subject matter, of prior-filed U.S. Provisional Application Ser. No. 63/518,139, entitled “CRUSHABLE CRASH CUSHION TRANSITION”, filed on Aug. 8, 2023. The Provisional Application is hereby incorporated by reference, in its entirety, into the current patent application.

### BACKGROUND

Vehicle impact absorbing systems, also called “crash cushions,” are often installed adjacent rigid structures such as pillars, bridge abutments, lighting poles and the like for absorbing vehicle impact energy and minimizing the effects of impact on a vehicle, the vehicle's occupants, and the structure being protected.

### SUMMARY

The present invention provides an improved means for attaching crash cushions to a rigid, protected structure.

An intermediate transition for connecting a crash cushion to a rigid structure includes a housing and an energy absorbing module. The housing defines an inner space and includes a top wall, a front wall, a rear wall, and a side wall. The front wall is operatively associated with the top wall and is operable to connect to the crash cushion. The rear wall is operatively associated with the top wall and is operable to connect to the rigid structure. The side wall is operatively associated with the top wall and includes a weakened portion. The energy absorbing module is located in the inner space of the housing.

Another embodiment of the invention is a crash cushion system for connecting to a rigid structure and absorbing energy when impacted by a vehicle. The crash cushion system includes a plurality of energy absorbing cushions and an intermediate transition. The intermediate transition is attached to the plurality of energy absorbing cushions and is operable to connect to the rigid structure. The intermediate transition includes a housing and an energy absorbing module. The housing defines an inner space and includes a top wall, a front wall, a rear wall, and a side wall. The front wall is operatively associated with the top wall and is operable to connect to the crash cushion. The rear wall is operatively associated with the top wall and is operable to connect to the rigid structure. The side wall is operatively associated with the top wall and includes a weakened portion. The energy absorbing module is located in the inner space of the housing.

An intermediate transition according to another embodiment of the invention includes a housing and an energy absorbing module. The housing defines an inner space and includes a top wall, a front wall, a rear wall, and side walls. The front wall is operatively associated with the top wall and is operable to connect to the crash cushion. The rear wall is operatively associated with the top wall and is operable to connect to the rigid structure. The side walls are operatively associated with the top wall and each include a top end, a bottom end, and vertically-extending slots. The top end is proximal to the top wall, and the bottom end is opposite to the top end. The vertically-extending slots are located between the top and bottom ends and spaced apart from the bottom end. The energy absorbing module is located in the inner space of the housing.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a perspective view of a crash cushion system constructed in accordance with embodiments of the invention.

FIG. 2 is a perspective view of an intermediate transition of the crash cushion system of FIG. 1 for securing to a rigid structure.

FIG. 3 is a rear perspective view of the intermediate transition and the rigid structure of FIG. 2.

FIG. 4 is a perspective view of the intermediate transition of FIG. 2.

FIG. 5 is a lowered perspective view of the intermediate transition of FIG. 2.

FIG. 6 is a partial perspective view of the intermediate transition of FIG. 2.

The drawing figures do not limit the present invention to the specific embodiments disclosed and described herein. The drawings are not necessarily to scale, emphasis instead being placed upon clearly illustrating the principles of the invention.

### DETAILED DESCRIPTION

Turning now to the drawing figures, a crash cushion system 10 constructed in accordance with embodiments of the invention is illustrated. The crash cushion system 10 may be installed adjacent a rigid structure 12 such as a pillar, bridge abutment, lighting pole, or the like for absorbing vehicle impact energy and minimizing the effects of impact on a vehicle, the vehicle's occupants and the structure being protected.

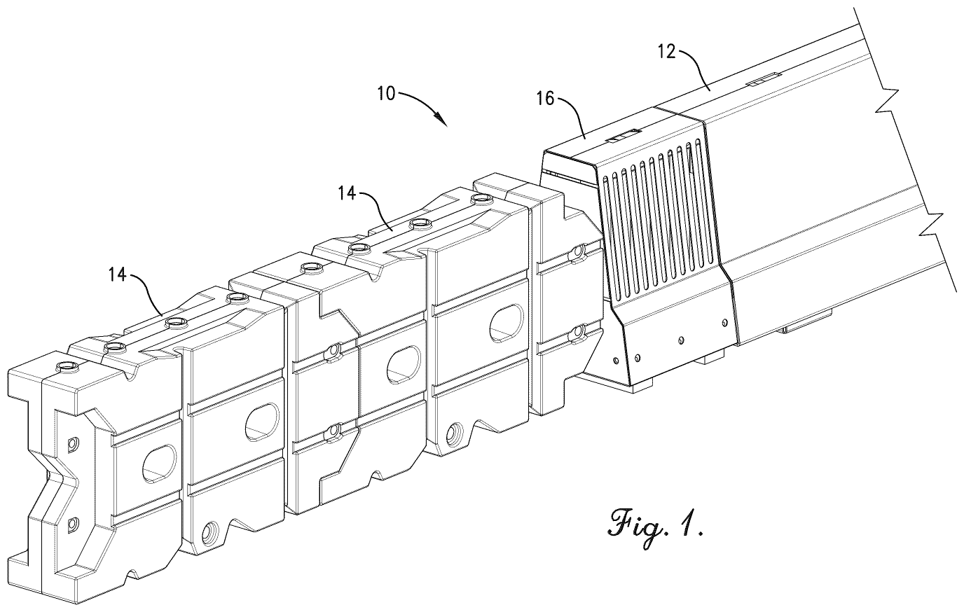

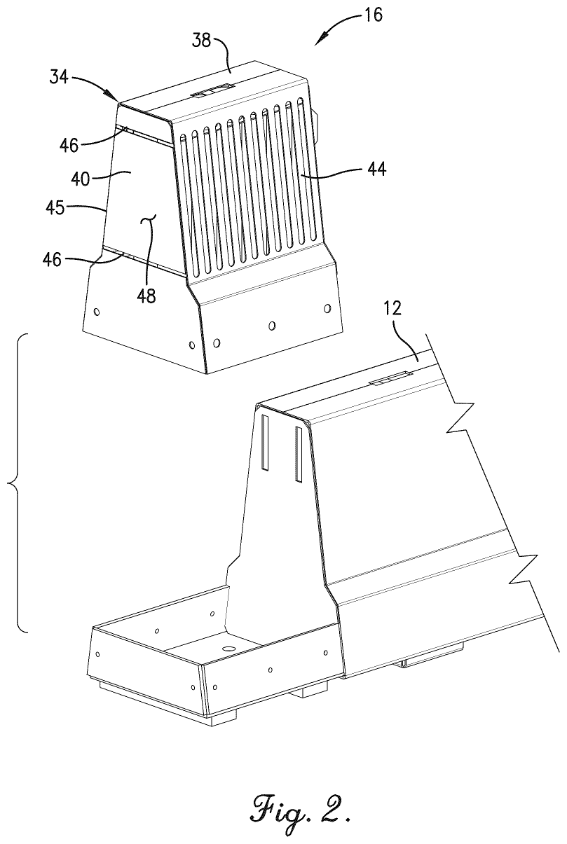

As best shown in FIG. 1, an embodiment of the crash cushion system 10 broadly comprises a number of energy absorbing cushions 14, such as water-filled elements 14, and an intermediate transition 16 that connects the cushions to the rigid structure 12. Additional preferred details of the energy absorbing cushions 14 are disclosed in U.S. Pat. No. 11,193,248, issued on Dec. 7, 2021, entitled Anchorless crash cushion apparatus including crash cushion stabilizing structure, which is hereby incorporated in its entirety by reference herein.

However, instead of the transition disclosed in U.S. Pat. No. 11,193,248, embodiments of the present invention include the intermediate transition 16 for attaching the cushions 14 to the rigid hazard object 12. The intermediate transition 16 helps accommodate angled vehicle impacts from the side. In some circumstances, a vehicle may miss most of the crash cushions 14 and contact the rigid end of the hazard 12 without properly engaging with the energy absorbing features of the crash cushions 14. In such cases, the transition 16 provides a softened and energy absorbing structure to increase safety for the vehicle occupant compared to impacting a rigid corner of the hazard. The transition 16 maintains sufficient rigidity that it does not affect the performance of the crash cushions 14 or the rigid hazard 12.

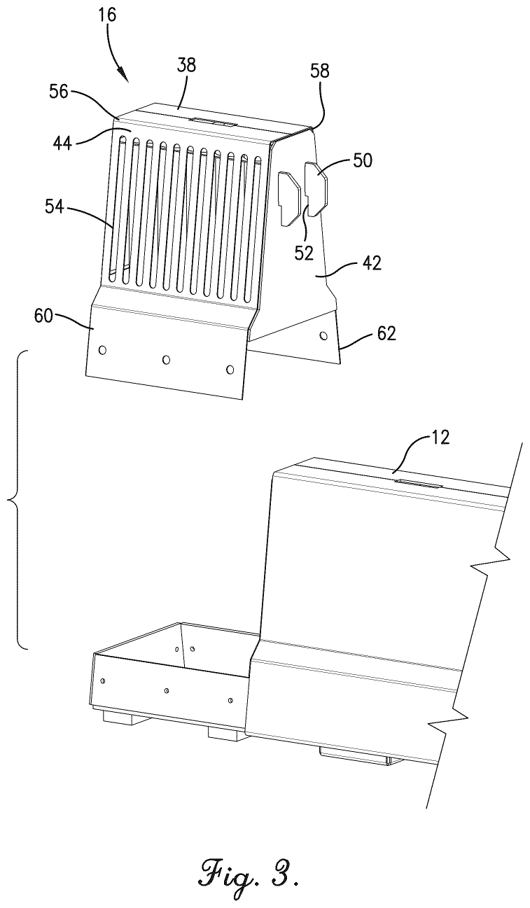

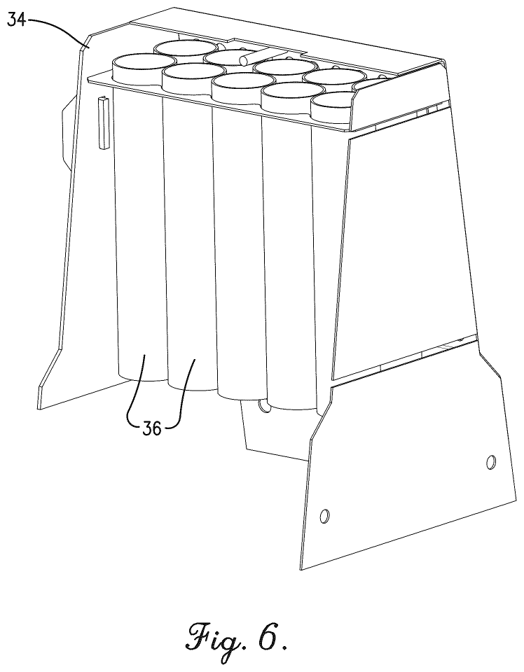

The intermediate transition 16 includes a housing 34 and one or more energy absorbing modules 36 (best shown in FIG. 6) housed within the transition housing 34. The housing 34 defines an inner space in which the energy absorbing modules 36 are located. In one or more embodiments, the housing 34 is shaped to have a vertical cross-sectional profile that matches a vertical cross-sectional profile of the rigid structure 12. In one or more embodiments, the housing 34 includes a top wall 38, a front wall 40, a rear wall 42 (depicted in FIG. 3), and side walls 44, 45.

The front wall 40 of the housing 34 is operatively associated with the top wall 38 of the housing 34 and is operable to connect to one of the crash cushions 14. The front wall 40 includes two horizontally extending slots 46 to define a middle region 48. The middle region 48 is generally located at a height for receiving a front end of an impacting vehicle during a crash.

Turning to FIG. 3, the rear wall 42 is operatively associated with the top wall 38 and is operable to connect to the rigid structure 12. In one or more embodiments, the rear wall includes two hook-shaped projections 50 that define slots 52 for engaging the rigid structure 12.

The side walls 44, 45 are operatively associated with the top wall 38 and include weakened portions 54 for helping direct a collapse of the housing 34 in the event of a collision. The side walls 44, 45 include top ends 56, 58 and bottom ends 60, 62. The top ends 56, 58 are proximal to the top wall 38, and the bottom ends 60, 62 are opposite to the top ends 56, 58. In one or more embodiments, the top wall 38 is formed by bent top ends of panels that also form the side walls 44, 45.

The weakened portions 54 are generally at a height of the middle region 48 of the front wall 40. In one or more embodiments, the weakened portions 54 are located between the top and bottom ends of the side walls 44, 45 and are spaced apart from the bottom ends so that they are closer to the top ends.

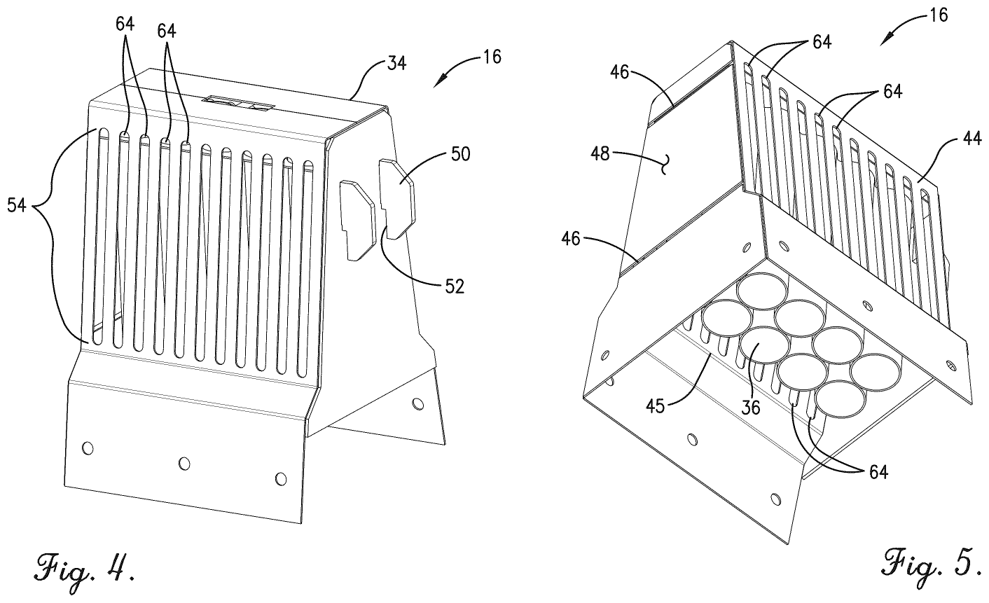

Turning to FIGS. 4 and 5, in one or more embodiments, the weakened portions 54 comprise vertically-extending slots 64 that span the height of the middle region 48. The horizontal slots 46 of the front wall 40 and the weakened portions 54 of the side walls 44, 45 collectively allow the side walls 44, 45 of the transition housing 34 to collapse when impacted from the front along the centerline of the apparatus 16.

Turning to FIG. 6, the energy absorbing modules 36 are located in the inner space of the housing 34.

### ADDITIONAL CONSIDERATIONS

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a nonexclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112 (f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. An intermediate transition for connecting a crash cushion to a rigid structure, the intermediate transition comprising:
a housing defining an inner space and comprising:
a top wall;
a front wall operatively associated with the top wall and operable to connect to the crash cushion;
a rear wall operatively associated with the top wall and operable to connect to the rigid structure; and
one or more side wall operatively associated with the top wall and including one or more weakened portion; and
one or more energy absorbing module located in the inner space.

2. The intermediate transition of claim 1, wherein the one or more weakened portion comprises one or more slot formed in the one or more side wall.

3. The intermediate transition of claim 2, wherein the one or more slot formed in the one or more side wall extends through a thickness of the one or more side wall.

4. The intermediate transition of claim 1, wherein the front wall includes two or more horizontally extending slots.

5. The intermediate transition of claim 4, wherein the two or more horizontally extending slots define a middle region located at a height for receiving a front end of a vehicle during a crash.

6. The intermediate transition of claim 5, wherein the weakened portion spans a height of the middle region.

7. The intermediate transition of claim 6, wherein the one or more energy absorbing module spans the height of the middle region.

8. A crash cushion system for connecting to a rigid structure and absorbing energy when impacted by a vehicle, the crash cushion system comprising:
a plurality of energy absorbing cushions; and
an intermediate transition attached to the plurality of energy absorbing cushions and operable to connect to the rigid structure, the intermediate transition comprising:
a housing defining an inner space and comprising:
a top wall;
a front wall operatively associated with the top wall and operable to connect to the plurality of energy absorbing crash cushions;
a rear wall operatively associated with the top wall and operable to connect to the rigid structure; and
one or more side wall operatively associated with the top wall and including one or more weakened portion; and
one or more energy absorbing module located in the inner space.

9. The crash cushion system of claim 8, wherein the one or more weakened portion comprises one or more slot formed in the one or more side wall.

10. The crash cushion system of claim 9, wherein the one or more slot formed in the one or more side wall extends through a thickness of the one or more side wall.

11. The crash cushion system of claim 8, wherein the front wall includes two or more horizontally extending slots.

12. The crash cushion system of claim 11, wherein the two or more horizontally extending slots define a middle region located at a height for receiving a front end of a vehicle during a crash.

13. The crash cushion system of claim 12, wherein the weakened portion spans a height of the middle region.

14. The crash cushion system of claim 13, wherein the one or more energy absorbing module spans the height of the middle region.

15. An intermediate transition for connecting a crash cushion to a rigid structure, the intermediate transition comprising:
a housing defining an inner space, and comprising:
a top wall;
a front wall operatively associated with the top wall and operable to connect to the crash cushion;
a rear wall operatively associated with the top wall and operable to connect to the rigid structure;
side walls operatively associated with the top wall and each of the side walls including a top end proximal to the top wall, a bottom end opposite the top end, and a plurality of vertically-extending slots located between the top and bottom ends and spaced apart from the bottom end; and
one or more energy absorbing module located in the inner space.

16. The intermediate transition of claim 15, wherein the front wall includes two or more horizontally extending slots.

17. The intermediate transition of claim 16, wherein the two or more horizontally extending slots define a middle region located at a height for receiving a front end of a vehicle during a crash.

18. The intermediate transition of claim 17, wherein the vertically-extending slots span a height of the middle region.

19. The intermediate transition of claim 18, wherein the one or more energy absorbing module spans the height of the middle region.

20. The intermediate transition of claim 15, wherein the housing is shaped to have a vertical cross-sectional profile that matches a vertical cross-sectional profile of the rigid structure.
